(19) United States
(12) Patent Application Publication
(10) Pub. No.: US 2018/0029911 A1
(43) Pub. Date: Feb. 1, 2018

(54) STANDBY WATER SOURCE FILTER SYSTEM

(71) Applicant: TAT-YUNG NG, NORTH POINT (HK)

(72) Inventor: TAT-YUNG NG, NORTH POINT (HK)

(21) Appl. No.: 15/609,451

(22) Filed: May 31, 2017

(30) Foreign Application Priority Data
Jul. 26, 2016 (CN) 201620792468.3

(51) Int. Cl. C02F 9/00; B01D 39/16; B01D 39/06; B01D 36/02

(52) U.S. Cl. CPC C02F 9/00; B01D 36/02; B01D 39/1615; B01D 39/06; C02F 1/004

(57) ABSTRACT

Disclosed is a standby water source filter system comprising a filter device, a water pump, water softening equipment and a reverse osmosis (RO) device, wherein the filter device, the water softening equipment and the reverse osmosis (RO) device are sequentially connected in series, an inlet of the filter device is connected with a standby water source, and an outlet of the reverse osmosis (RO) device is connected with downstream water-production equipment. The standby water source filter system can remove impurities, bacteria and saline matter in water through filtering, softening and reverse osmosis (RO), raw material conditions required by the downstream water-production equipment are met, and the service life of the downstream water-production equipment is prolonged.

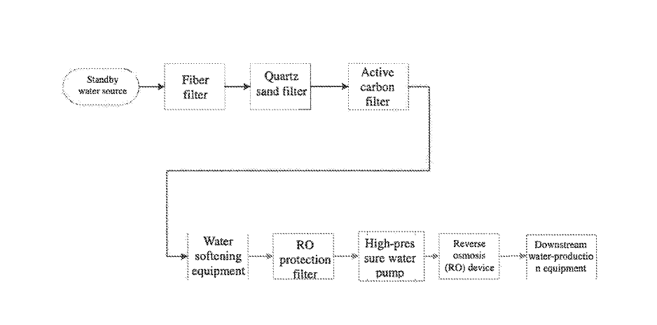

### BACKGROUND OF THE INVENTION

### Technical Field

The invention relates to water treatment equipment, in particular to a standby water source filter system.

### Description of Related Art

Existing fresh water resources which can be easily utilized by humans are mainly from rivers, lakes and shallow groundwater; fresh water resources are deficient due to large consumption, and clean water resources in places with abundant electricity and energy are also relatively deficient and need to be saved and protected due to serious pollution and extremely imbalanced regional distribution; water resources have already been precious resources for humans, and water resource problems have even become a major strategy concerning sustainable development of the national economy and society, and lasting political stability.

In certain remote arid and distressed areas where clean water resources are extremely difficult to obtain and water resource shortages exist, it is hard to lay long delivery pipelines for long-distance supply of drinking water, or to transport drinking water back and forth through transportation facilities without considering transportation costs, or to mount large water quality optimization systems, and consequentially, the cost of safe drinking water becomes extremely high; besides the high drinking water cost, water quality changes or secondary pollution can be caused by long-distance delivery or transportation, and consequentially, water cannot be directly drunk by people safely.

Although the personal demand for drinking water of people in daily life is not large, the requirements for the sanitation, cleanliness, sterility and non-toxicity of the drinking water are high; drinkable pure water can be obtained through air purification and condensation, however, a standby water source is needed when the pure water obtained through air purification and condensation is insufficient in certain seasons or in places with insufficient air humidity. Since water supplied by the standby water source generally cannot meet the water-production standards, the service life of downstream water-production equipment is affected, and the water can only enter a downstream water-production system after being treated.

### BRIEF SUMMARY OF THE INVENTION

For solving the technical problems, the invention provides a standby water source filter system which can pre-treat water provided by a standby water source.

According to the technical scheme adopted by the invention for solving the technical problems, the standby water source filter system comprises a filter device and a water pump, and is characterized by further comprising water softening equipment and a reverse osmosis (RO) device, wherein the filter device, the water softening equipment and the reverse osmosis (RO) device are sequentially connected in series, an inlet of the filter device is connected with the standby water source, and an outlet of the reverse osmosis (RO) device is connected with downstream water-production equipment.

The standby water source filter system is characterized in that the filter device comprises a fiber filter, a quartz sand filter and an active carbon filter, wherein the fiber filter, the quartz sand filter and the active carbon filter are sequentially connected in series, an inlet of the fiber filter is connected with the standby water source, and an outlet of the active carbon filter is connected with the water softening equipment.

The standby water source filter system is characterized in that the fiber filter comprises a PP cotton filer and a fiber mesh filter.

The standby water source filter system is characterized in that the water pump is connected between the water softening equipment and the reverse osmosis (RO) device.

The standby water source filter system is characterized by comprising an RO protection filter, wherein the RO protection filter is connected between the water softening equipment and the water pump.

The standby water source filter system of the invention can remove impurities, bacteria and saline matter in water through filtering, softening and reverse osmosis (RO), raw material water conditions required by the downstream water-production equipment are met, and the service life of the downstream water-production equipment is prolonged.

### BRIEF DESCRIPTION OF THE SEVERAL VIEWS OF THE DRAWINGS

A further detailed description of the invention is given with the accompanying drawing and the specific execution mode as follows.

The FIGURE is a chart of a standby water source filter system of an embodiment of the invention.

### DETAILED DESCRIPTION OF THE INVENTION

The FIG. shows the structure of a standby water source filter system of an embodiment of the invention, and the standby water source filter system comprises a filter device, a high-pressure water pump, water softening equipment, an RO protection filter and a reverse osmosis (RO) device, wherein the filter device, the water softening equipment, the RO protection filter and the reverse osmosis (RO) device are sequentially connected in series, the high-pressure water pump is connected between the RO protection filter and the reverse osmosis (RO) device, an inlet of the filter device is connected with a standby water source, and an outlet of the reverse osmosis (RO) device is connected with downstream water-production equipment.

Wherein, the filter device comprises a fiber filter, a quartz sand filter and an active carbon filter, the fiber filter, the quartz sand filter and the active carbon filter are sequentially connected in series, an inlet of the fiber filter is connected with the standby water source, and an outlet of the active carbon filter is connected with the water softening equipment.

In the embodiment, the fiber filter comprises a PP cotton filter and a fiber mesh filter.

According to the standby water source filter system of the embodiment of the invention, impurities in the standby water source which can be tap water or a polluted water source are removed through the PP cotton filter, the quartz sand filter and the active carbon filter, then water is softened through electrolysis by the water softening equipment, the softened water then enters the RO protection filter, and the water source is pressurized through the high-pressure water pump and directly pumped to a reverse osmosis (RO) system to be purified. Finally, the purified water source is connected to the downstream water-production equipment.

In this way, when the air humidity is too low, an air conversion and condensation electro-magnetization system can use tap water or a polluted water source as the standby water source for producing bottled magnetized pure water through the standby water source filter system.

What is claimed is:

1. A standby water source filter system, comprising a filter device and a water pump, characterized by further comprising water softening equipment and a reverse osmosis (RO) device, wherein the filter device, the water softening equipment and the reverse osmosis (RO) device are sequentially connected in series, an inlet of the filter device is connected with a standby water source, and an outlet of the reverse osmosis (RO) device is connected with downstream water-production equipment.

2. The standby water source filter system according to claim 1, characterized in that the filter device comprises a fiber filter, a quartz sand filter and an active carbon filter, wherein the fiber filter, the quartz sand filter and the active carbon filter are sequentially connected in series, an inlet of the fiber filter is connected with the standby water source, and an outlet of the active carbon filter is connected with the water softening equipment.

3. The standby water source filter system according to claim 2, characterized in that the fiber filter comprises a PP cotton filter and a fiber mesh filter.

4. The standby water source filter system according to claim 1, characterized in that the water pump is a high-pressure water pump, and the high-pressure water pump is connected between the water softening equipment and the reverse osmosis (RO) device.

5. The standby water source filter system according to claim 4, characterized by comprising an RO protection filter, wherein the RO protection filter is connected between the water softening equipment and the water pump.
